(19) United States
(12) Patent Application Publication
(10) Pub. No.: US 2019/0041973 A1
(43) Pub. Date: Feb. 7, 2019

(54) System and Method for Providing Selective Notifications and Contextual Information

(71) Applicant: QUALCOMM Incorporated, San Diego, CA (US)

(72) Inventors: Ankit MAHESHWARI, Hyderabad (IN); Shruti AGRAWAL, Hyderabad (IN); Suraj CHINCHOLIMATH, Hyderabad (IN); Ankur MAHESHWARI, Hyderabad (IN)

(21) Appl. No.: 15/669,778

(22) Filed: Aug. 4, 2017

(51) Int. Cl. G06F 3/01; G06F 3/16; G10L 19/018; H04N 21/44; H04L 29/08; H04N 21/439

(52) U.S. Cl. CPC G06F 3/011; G06F 3/167; G10L 19/018; G02B 27/017; H04L 67/26; H04N 21/4394; H04N 21/44008

(57) ABSTRACT

This disclosure provides systems and methods operating a virtual reality (VR) system. The VR system can have a head mounted device (HMD) to provide alerts based on notifications from surrounding internet of things (IoT) devices. The method can include storing, in a memory, one or more sound patterns, each sound pattern of the one or more sound patterns being associated with one of a critical event and a non-critical event. The method can include receiving, at a processor, a notification from a home device of one or more of home devices, the notification indicating a status change of the home device. The method can include determining that the notification corresponds to a critical event based on the one or more sound patterns. The method can include providing a critical message via the HMD of the VR system indicating that the critical event has occurred.

### BACKGROUND

### Technological Field

This disclosure relates to Virtual Reality (VR) systems. More specifically, this disclosure relates to providing selective notifications and contextual information within a VR device to alert the user of information related to a surrounding environment.

### Related Art

Some virtual reality (VR) systems implement VR equipment, such as a head mounted display (HMD), that fully covers the eyes during a VR experience. While the VR system can provide an immersive media (audio, video, etc.) experience to an end user, it is also possible that the user may lose track of events occurring around him or her. For example, the VR system may distract a user from events or aural (e.g., audio, acoustic) cues that require the user's immediate attention.

Some VR devices can be paired with external devices such as a mobile electronic device, for example, a smartphone. An incoming call, message, or calendar notification on the mobile device can be displayed on the paired VR device coupled to the mobile device. However, in the connected world of Internet of Things (IoT) devices, there are many other surrounding sounds, activities, and/or notifications from other external devices that may be overlooked or ignored given the distraction of the VR experience.

Moreover, conventional methods typically provide only for notifications from paired devices that are limited to calls, messages, and calendar events.

### SUMMARY

In general, this disclosure describes systems and methods that selectively enable display of critical and/or priority notifications from connected IoT devices on VR equipment. The systems, methods and devices of this disclosure each have several innovative aspects, no single one of which is solely responsible for the desirable attributes disclosed herein.

One aspect of the disclosure provides a method for operating a virtual reality (VR) system having a head mounted device (HMD) to provide alerts. The method can include storing, in a memory, one or more sound patterns, each sound pattern of the one or more sound patterns being associated with one of a critical event and a non-critical event. The method can include receiving, at a processor, a notification from a home device of one or more of home devices, the notification indicating a status change of the home device. The method can include determining that the notification corresponds to a critical event based on the one or more sound patterns. The method can include providing a critical message via the HMD of the VR system indicating that the critical event has occurred.

Another aspect of the disclosure provides a device for providing an alert by a virtual reality (VR) system having a head mounted device (HMD). The device can have a memory configured to store one or more sound patterns, each sound pattern of the one or more sound patterns being associated with one of a critical event and a non-critical event. The device can have one or more processors. The one or more processors can receive a notification from a home device of one or more of home devices, the notification indicating a status change of the home device. The one or more processors can determining that the notification corresponds to a critical event based on the one or more sound patterns. The one or more processors can provide a critical message via the HMD of the VR system indicating the critical event has occurred.

Another aspect of the disclosure provides a non-transitory computer readable medium comprising instructions for providing an alert in a virtual reality (VR) system having a head mounted device (HMD). The instructions can cause a processor to store, in a memory, one or more sound patterns, each sound pattern of the one or more sound patterns being associated with one of a critical event and a non-critical event. The instructions can cause a processor to receive, at a processor, a notification from a home device of one or more of home devices, the notification indicating a status change of the home device. The instructions can cause a processor to determine that the notification corresponds to a critical event based on the one or more sound patterns. The instructions can cause a processor to provide a critical message via the HMD of the VR system indicating the critical event has occurred.

Another aspect of the disclosure provides a method for providing an alert by a virtual reality (VR) system having a head mounted device (HMD). The method can include storing, in a memory, a georeferenced boundary associated with a corresponding warning zone, and one or more sound patterns, each sound pattern of the one or more sound patterns being associated with one of a critical event and a non-critical event. The method can include detecting, at a processor, an alert. If the alert comprises an audible notification from a home device of one or more of home devices, the method can include determining that the notification corresponds to a critical event based on the one or more sound patterns and providing a critical message via the HMD of the VR system indicating the critical event has occurred. If the alert comprises an indication that the HMD is approaching the georeferenced boundary, the method can include providing a video feed of an external environment via the HMD.

Other features and advantages of the present disclosure should be apparent from the following description which illustrates, by way of example, aspects of the disclosure.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a graphical representation of an operating environment for extended reality devices;

FIG. 2 is a functional block diagram of an embodiment of a device for use with the extended reality environment of FIG. 1; and

FIG. 3 is a flowchart of an embodiment of a method for providing alerts within the extended reality environment of FIG. 1.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. In some instances, well-known structures and components are shown in simplified form for brevity of description.

This disclosure describes systems and methods that enable display of critical and/or priority notifications from various IoT devices on one or more extended reality (XR) devices. This capability can aid a user in situational awareness even when immersed in a VR experience. While VR may be used as the primary example herein, this is not limiting on the implementation of the system. Some further examples include augmented reality (AR), mixed reality (MR), augmented virtuality (AV), and other forms of real-and-virtual combined environments and human-machine interactions generated by computer technology and wearables. AR, AV, VR, and MR may also be referred to generically as XR environments. As used herein, notification may be used to represent alerts, indications, or messages from XR systems.

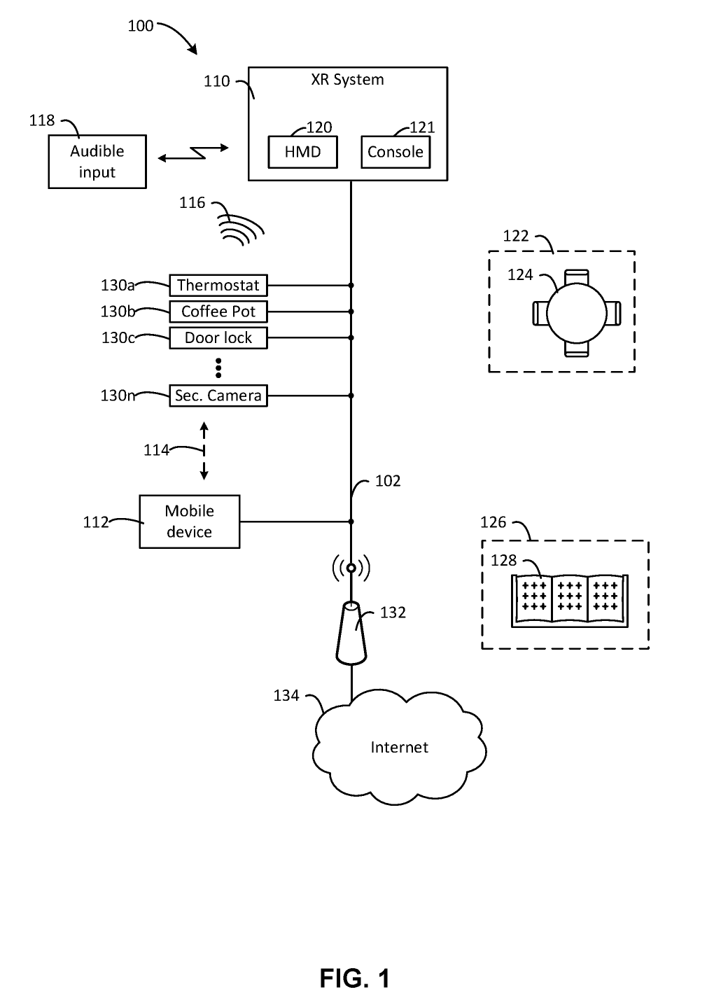

FIG. 1 is a graphical representation of an operating environment for extended reality devices. An operating environment (environment) 100 can be, for example, a home, common area, office, or other area in which an XR system is implemented.

The environment 100 can have an XR system 110. The XR system 110 can provide a user or wearer an immersive computer generated experience having only virtual elements or combined real and virtual elements. The XR system 110 can have a head-mounted device (HMD) 120 to provide visual effects to the user. The XR system 110 can also have a console 121 including the electronic components that power the XR system 110, for example. The HMD 120 can have a direct wireline connection to the console 121. The HMD 120 can also be coupled to the console 121 via a wireless connection.

The environment 100 can have one or more IoT devices 130 (labeled individually as 130a, 130b, 130c through 130n). For example, the IoT devices 130 can be one of a variety of home devices or smart home devices having wireless or wired communication capabilities. For example, the IoT devices can be a smart thermostat 130a, a coffee pot 130b, an Internet-enabled door lock 130c, or a security camera 130n from a smart security system. Other examples of the IoT devices 130 may be a smart refrigerator, or other internet-enabled home device. The IoT device 130 can be communicatively coupled to a wireless network 102, for example, within the environment 100. The wireless network 102 can be provided by an access point (AP) 132. The AP 132 can also provide a connection to the Internet 134. The AP 132 can provide the wireless network 102 (e.g., on an IEEE 802.11 family of protocols) that is accessible by devices within the environment 100. For example, the console 121, the HMD 120, and the mobile device 112 can each be communicatively coupled to each other via the wireless network 102. Such devices may also be able to communicate via the Internet 134 via the AP 132.

In some embodiments, the XR system 110 can provide a given XR experience. The XTR system can further selectively pause the XR experience based on alerts or events or other inputs detected from the environment 100 surrounding the user. The selective pausing can be based on predetermined messages, cues, alerts, sound patterns, communications from the IoT devices 130, or other criteria that identify and/or correspond with situations or events important to and/or selected by the XR user. Such messages, messages, cues, alerts, sounds, sound patterns (e.g., a tone or a tune), or other criteria can correspond with an output configuration 116 transmitted by of one or more of the IoT devices 130. As used herein, the output configuration 116 can include a sound (or sound pattern), or various transmissions or messages generated by the IoT devices 130. The output configuration(s) 116 can be stored in memory by the user within the XR system 110 or provisioned within the XR system 110 and use to determine the nature of a given alert.

In some embodiments the output configuration 116 can include an electronic message can sent from the IoT devices 130 to the XR system 110. The electronic message or other communication can be transmitted via the network 102 or various wireless communication protocols. The XR system 110 can selectively pause a given XR experience and/or alert the user via the HMD 120 based on such an electronic message (e.g., the output configuration 116).

An audible input 118 (or audio input) or other sounds that are not necessarily associated with the IoT devices 130 may also be stored. Such audible inputs 118 may include associated voice recognition (e.g., someone calling the name of the user), a siren or other emergency sound, and/or various alerts within the environment 100. Some sounds may only need to be louder than a predetermined threshold to elicit a response from the XR system 110.

The system can also provide mechanisms to inform the XR user of potential hazardous obstacles. For example, the XR system 110 can provide a warning if the user approaches a warning area, or a warning zone 122 or a warning zone 126. The warning zone 122 is shown identifying a table 124. The warning zone 126 is shown surrounding a couch 128. The warning zone 122 and the warning zone 126 can be areas having a location-based identifier. The warning zone 122 and the warning zone 126 can be also be one or more georeferenced boundaries. When the HMD 120 (and the user) approaches within a predetermined distance, or enters the warning zones 122, 126, the XR system 110 can provide an alert to the user and/or pause the XR experience. Other obstacles such as walls, staircases, doorways, etc., and associated warning zones, may be stored by the device 200. As the HMD 120 (and XR user) approaches the warning zone 122, 126, the HMD 120 may provide an indication to the XR user. The HMD 120 can further display a view (via, for example, an external camera) of the environment 100 as needed to allow the user to avoid any obstacles.

The disclosure addresses a number of scenarios in which the user may be otherwise occupied watching media content or playing games using the HMD 120 or other associated devices. In a first example, the XR system 110 can manage notifications from the IoT devices 130 within a Home Network (e.g., the network 102). In a second example, the XR system 110 can manage notifications from other audio sources, such as, other users in proximity, random sounds, etc. In a third example, the XR system 110 can provide information to a VR user if proximity to any hazardous or warning zones (e.g., the warning zones 122, 126) is detected.

In some embodiments, the environment 100 can be a connected Internet of Everything (IoE) environment such as a so-called Smart Home, in which connectivity capabilities may be inherent to various devices around the home (e.g., home devices). The IoT device(s) 130 can be any connected- or smart-device, from a mattress cover to thermostats to coffee pots, configured to provide a user with notifications.

In some embodiments, such notifications or alerts can be routed to the mobile device 112 for example (e.g., a smartphone) to alert the user. A connection 114 may be established between the IoT device 130 and the mobile device 112 via a point-to-point or device-to-device connection such as, Bluetooth, ZigBee, WeMo, or other relevant wireless connections. The connection 114 can provide a paired connection between the mobile device and the IoT devices 130. The connection 114 can provide relevant alerts or notifications to the mobile device 112. Notifications may also be routed from the IoT devices 130 to the mobile device 112 via the home network 102.

However, a user wearing a VR headset (e.g., the HMD 120), for example, may not be able to conveniently address each and every notification from the various IoT devices 130, particularly those sent to the mobile device 112. For example, the user may not be concerned about an alert from the coffee pot 130b that the coffee is done, but an alert from an IoT door lock 130c may be of significant importance. If the alert is provided only to the mobile device 112 while the user is wearing the HMD 120, the user may be unaware the door lock 130c had been locked or unlocked.

In some embodiments, the alerts or indications from the associated IoT devices 130 can be based on a status change of the IoT device 130. The alerts, or changes in status, can be provided via the output configuration 116 or the audible input 118. The output configuration 116 or the audible input 118 can further be classified, for example, as a critical- or non-critical event. As used herein, a critical event is one for which the user may desire immediate notification. For example, a critical event may comprise an alarm from a baby monitor, a security alarm, or other notification that represents an emergency or other important situation. As used herein, a non-critical event may be any event that is not considered, or otherwise defined as critical. Non-critical events can be non-emergent or events not requiring the user's immediate attention and thus be associated with a non-critical alert. For example, an indication that a smart washing machine has completed a cycle or that the coffee in the coffee pot 130b is done, may be sent to the mobile device 112 for later review by the user. The foregoing are merely examples of labels of critical and non-critical events (and associated alerts or notifications). Such labels of classifications may be user-defined. In some other embodiments, some critical and non-critical events may be predefined or provisioned in the XR system 110. Embodiments of the disclosed method and system can address critical events by indicating them to user via a critical or non-critical alert or message on the HMD 120, for example. Additionally, non-critical alerts can be stored or forwarded, for example, to the mobile device 112 for later review by the user.

In some embodiments, the XR system 110 may receive all external sounds or messages (e.g., critical and non-critical alerts), but may only process the alerts corresponding to critical events. In some embodiments, the XR system 110 can be configured to address both critical and non-critical alerts, but only critical alerts may be displayed on the HMD 120, for example. In such a case, the coffee pot 130b may be coupled to the mobile device 112 and receive an indication (e.g., via the connection 114) that the coffee is done. The coffee pot 130b may further have a noise or other indication (e.g., the output configuration 116 or the audible input 118) associated with the completion of the pot. In such case, for example, the XR system 110 may receive the noise indication from the coffee pot 130b but do nothing since the coffee pot does not correspond with a critical event.

In some embodiments, the XR system 110, for example, can store various sound patterns or electronic messages for designated alerts, based on the output configuration 116 from the various IoT devices 130 (coffee pot, thermostat, washing machine, doorbell, security devices, etc.). The user can also configure a variety of text or audio patterns (e.g., the audible input 118), such as a spoken name or phrase or other expected sounds (e.g., dog bark in case of pets, infant cry, etc.) that can be considered a critical alert associated with a critical event, for example.

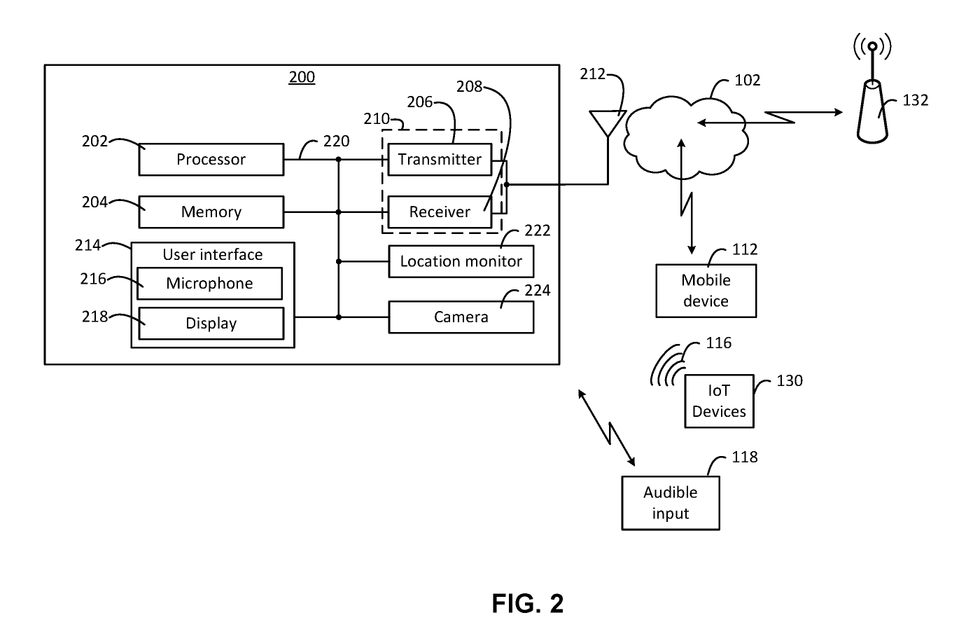

FIG. 2 is a functional block diagram of a device for use with the environment of FIG. 1. A device 200 can be configured to implement the various methods described herein. For example, the device 200 can be implemented in the environment 100 as the XR system 110, the HMD 120, the console 121, or various combinations thereof. For ease of description, the XR system 110 may be described as a single unit in connection with the device 200 and FIG. 2. However, one of ordinary skill will recognize that the HMD 120 and the console 121 may be separate entities communicatively coupled to provide the user with an XR/VR experience.

The device 200 can include a processor 202. The processor 202 can be implemented as one or more processors or processor units. The processor 202 can also be referred to as a central processing unit (CPU). The processor 202 can control operation of the device 200. The processor 202 can implement the steps of the methods described herein. The processor 202 can perform the tasks associated with any one of the components of the XR system 110, for example. The processor 202 can perform the various steps within the following flowchart(s), combining, overlapping, repeating, or performing them out of order as needed.

The device 200 can also have a memory 204 coupled to the processor 202. The memory 204 can include both read-only memory (ROM) and random access memory (RAM). The memory 204 can provide instructions and data to the processor 202. At least a portion of the memory 204 can also include non-volatile random access memory (NVRAM). The processor 202 can perform logical and arithmetic operations based on program instructions stored within the memory 204. The instructions in the memory 204 can be executable to implement the methods described herein. In some embodiments, the memory 204 can be implemented to store and manage definitions for critical and non-critical events. The processor 202 can store the output configuration 116 for various IoT devices 130, to the memory 204, for example. The processor 202 can also store words, text, sounds, or other indications (e.g., the audible input 118) that identify events defined as critical and/or non-critical. As noted above, the identification of an event or alert as critical and non-critical may be user-defined, predetermined, or provisioned with the device 200.

The processor 202 can include or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. In some embodiments, the processor 202 can at least partially implement cloud computing or multiple distributed processors as needed.

The processor 202 and the memory 204 can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The device 200 can have a transmitter 206 and/or a receiver 208 to allow transmission and reception of data between the device 200 and a remote location via, for example, a network connection associated with the network 102 and other connectivity described herein. The transmitter 206 and the receiver 208 can be combined into a transceiver 210. In some embodiments, the IoT devices 130 can transmit one or more output configurations 116 via a wireless connection (e.g., the network 102) that is received at the transceiver 210. The device 200 can also have one or more antennas 212 electrically coupled to the transceiver 210. The device 200 can also include (not shown) multiple transmitters, multiple receivers, multiple transceivers, and/or multiple antennas as needed for various communication standards and communication with, for example, the mobile device 112, the IoT devices 130, and the AP 132.

The transmitter 206 can be configured to wirelessly transmit packets having different packet types or functions. For example, the transmitter 206 can be configured to transmit packets of different types generated by the processor 202.

The receiver 208 can be configured to wirelessly receive packets having different packet types. In some examples, the receiver 208 can be configured to detect a type of a packet used and to process the packet accordingly.

In some embodiments, the transmitter 206 and the receiver 208 can be configured to transmit and receive information via other wired or wireline systems or means.

The device 200 can have a user interface 214. The user interface 214 can have, among other components, a microphone 216 and a display 218, for example. In some embodiments, the device 200 can further have a keypad, a speaker, a touchscreen, remote controller, and/or other peripheral components that allow the user to interact with the device 200. The user interface 214 can include any element or component that conveys information to a user of the device 200 and/or receives input from the user. In some embodiments, the HMD 120 (FIG. 1) can be a part of the user interface 214 (e.g., the display 218). For example, the HMD 120 can have the microphone 216 and the display 218, in addition to one or more speakers. The microphone 216 can be implemented onboard the HMD 120. In some other embodiments, the console 121 can also have an onboard microphone (e.g., the microphone 216) and/or speakers as required.

In some embodiments, the microphone 216 can receive sounds emitted within the environment 100, such as the output configuration 116 and the audible input 118. The processor 202 can use, for example, a DSP to process such sounds to determine if the received sounds are associated with a critical or non-critical event and provide an alert to the user as needed.

The device 200 can further have a location monitor 222. The location monitor 222 can perform location finding tasks to determine a position of the device 200 within the environment 100. In some embodiments, the location monitor 222 can have a global positioning system (GPS) receiver that can determine a position of the device 200 in three dimensions within the environment 100. In some other embodiments, the location monitor 222 can use triangulation or trilateration of various wireless signals (cellular, WiFi, or otherwise) to determine a position within the environment 100.

In some other embodiments the location monitor 222 can be implemented in one of the HMD 120 and the console 121 and use a point-to-point location system to determine a position of the HMD 120 relative to the XR device, and within the environment 100. For example, if the console 121 comprises a stationary game console, then as the user moves around the environment wearing the HMD 120, then the HMD 120 can use the location monitor 222 to determine a relative position to the known, stationary position of the console 121. In some embodiments the device 200 (and e.g., the HMD 120 and the console 121) can implement various combinations of the foregoing in order to determine a position of the device 200 and its various moveable components (e.g., the HMD 120) within the environment 100. In some other embodiments, the XR system 110 can comprise an instrumented, three-dimensional, location tracking system. Such a location tracking system can include various sensors positioned within the environment 100 that can track the position of the HMD 120, for example, to provide the immersive XR experience.

In some embodiments, the location monitor 222 can be used to geotag the warning zone 122 and the warning zone 126, for example. The processor 202 can store the geotags of the warning zones 122, 126 to the memory 204. The processor 202 can then provide an appropriate critical or non-critical alert to HMD 120 for display to the user when the HMD 120 approaches the warning zones 122, 126. If more than one user is present, and more than one HMD 120 is in use with the XR system 110, for example, alerts may also be provided to each of the HMDs 120 in the event they close to within a threshold distance.

The location monitor 222 is shown as a separate component of the device 200 for ease of description. The location monitor 222 can also be a portion of another location tracking component or share responsibilities for the performance of location finding with, for example, the processors 202, the transceiver 210, and other components. Additionally, the HMD 120 and the console 121 can each have an individual location monitor 222 as needed.

The device 200 can further have an external camera 224. The external camera 224 can provide a video input of the environment 100 for display, for example, on the display 218 of the HMD 120. In some embodiments, such a feature may be useful to provide a display of the environment 100 to the user without removing the HMD 120. For example, if the user and HMD 120 approach the warning zone 122, 126, the processor 202 can provide an external view so that the user can avoid obstacles in his or her path. The external camera 224 may also be a component of the console 121 that aids in sensing the position of the user using the HMD 120.

The various components of the device 200 can be coupled together by a bus system 220. The bus system (bus) 220 can include a data bus, for example, as well as a power bus, a control signal bus, and a status signal bus in addition to the data bus. The components of the device 200 can be coupled together or accept or provide inputs to each other using some other mechanism. The bus 220 can further include an applicable wireline or wireless connection between the HMD 120 and the console 121, for example.

Although a number of separate components are illustrated in FIG. 2, one or more of the components can be combined or commonly implemented, as in the HMD 120 and the console 121, for example. In some examples, the processor 202 can be used to implement not only the functionality described above with respect to the processor 202, but also to implement functionality with respect to a signal detector a digital signal processor (DSP), or other functions. In some embodiments, each of the components illustrated in FIG. 2 can be implemented using a plurality of separate elements.

As used herein, a “current VR activity” may be one in which the user is presently engaged and may be otherwise distracted from events and occurrences in the surrounding environment 100. In some embodiments, if the current VR activity does not require the use of the microphone 216 (e.g., in the HMD 120), or the microphone 216 is switched off while the HMD 120 is in use, the processor 202 can activate the microphone 216 to detect sounds from surrounding sources (e.g., within the environment 100). The processor 202 can correlate such sounds to one of a critical and a non-critical event and provide an alert to the HMD 120 (e.g., the display 218) accordingly.

In some embodiments, if the current VR activity does require the use of the microphone 216, the microphone on the paired mobile device 112 may be used for a similar purpose. If the mobile device 112 detects a critical alert, an indication can be sent to the device 200 for appropriate display to the user.

In other embodiments, an additional microphone can be installed on the exterior of the VR gear (e.g., the console 121) or headset (e.g., HMD 120) and be used for detecting the contextual sounds. The processor 202 can receive and process such sounds and provide an appropriate alert to the user.

The device 200 can process external sounds from the IoT devices 130 to determine the source device. In some embodiments, the processor 202 can include Speech-to-Text capabilities to process incoming audio from other users and matched with pre-stored speech or sound patterns in the memory 204.

In some examples, the microphone 216 of the device 200 (or e.g., the HMD 120, the console 121) may not need to be constantly enabled. Similarly the microphone of the mobile device 112 may not need to be constantly activated. For a given XR media stream, the media sound level may constantly fluctuate (e.g., not a constant volume or level). If the sound associated with the XR media is below a pre-determined threshold, the user may be able to listen to sounds within the environment 100 while using the device 200.

In some embodiments, the device 200 may further selectively enable or disable the microphone 216 based on such a threshold value. The volume threshold may be user defined or provisioned as needed.

In some embodiments, the environment 100 can be a home or office space. A user may be so immersed in the current VR activity requiring hand and/or body movement that there may be a potential for collision with another user, another device, or a nearby object. In such embodiments, specific areas (e.g., the warning zones 122, 126) surrounding the VR gear (e.g., the console 121) can be geotagged (e.g., stairs, walls, furniture, etc.). The device 200 can reference the geotags to inform provide an appropriate alert on the HMD 120 to the user that he or she is near a designated harmful area.

The device 200 may further pause the current VR activity or VR stream under certain circumstances. In an embodiment, the VR display can display an image of the surrounding environment to the user as an alert. Proximity to other static devices (e.g., walls, tables, etc.) can be detected which may prompt an alert to the user so that a corrective action to be taken. If other VR users are in close proximity, a warning or alert can be displayed based on the proximity to a detected harmful area/warning zone. An alert can also be displayed to the user in the HMD 120.

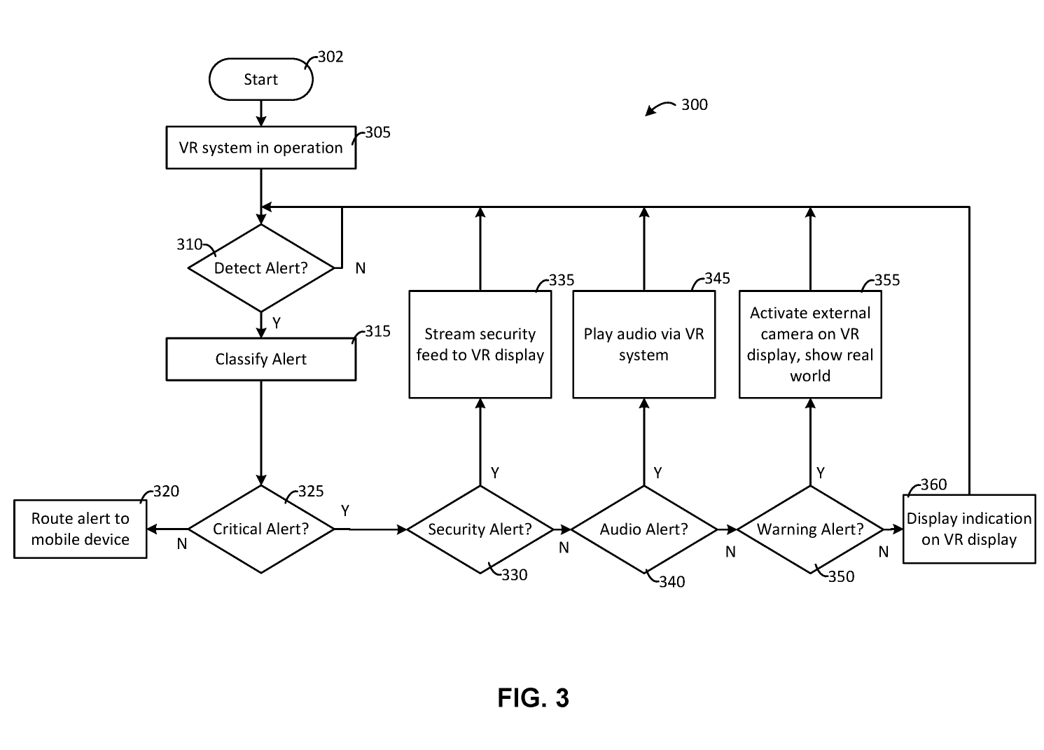

FIG. 3 is a flowchart of an embodiment of a method for providing alerts within the extended reality environment of FIG. 1. A method 300 can begin at block 302.

At block 305, the user can don the HMD 120 and activate the XR system 110 to experience an immersive XR environment. At decision block 310, the processor 202 (and, e.g., the microphone 216 and the receiver 208) can continuously monitor the environment 100 for alerts.

At decision block 310, if an alert is received at the processor 202 indicating a detected sound (e.g., the output configuration 116, or the audible input 118), then at block 315, the processor 202 can determine whether the alert identifies a critical event or a non-critical event.

At decision block 325, if the alert identifies a non-critical event, then at block 320, the processor 202 can route the alert to the mobile device 112. In some embodiments, if the non-critical event is associated with the IoT device 130 that communicates directly with the mobile device 112 (e.g., via a pairing or via the home network 102), the processor 202 may simply ignore the alert. For example, if the smart coffee pot 130b completes its operation, it may provide a noise (e.g., the output configuration 116) indicating that a pot of coffee is ready, for example. Such a noise may be identified by the processor 202 as non-critical and therefore not bother the user while operating the XR system 110. Similarly, if the smart coffee pot 130b completes its operation, it may alternatively provide a relevant message via a Bluetooth connection or via the home network 102 directly to the mobile device 112.

At decision block 325, if the processor 202 determines that the alert identifies a critical event, then at decision block 330, the processor can determine if the critical alert is a security alert. In some embodiments, the IoT devices 130 can include an internet-connected or otherwise “smart” security system having the door lock 130c and the security camera 130n.

At decision block 330, if the critical alert is a security alert then the processor 202 can provide a live video stream from the security camera 130n on the HMD 120, for example. Accordingly, the processor 202 can further pause the current VR activity to display the video feed.

At decision block 330, if the critical alert is not a security alert, at decision block 340, the processor 202 can determine if the critical alert is an audio alert. An audio alert may be a specific noise, voice profile, or other recording stored as the audible input 118 to the memory 204. The audio alert can be, for example, a baby crying, a security alarm, someone calling the name of the user, etc.

Once identified as an audio alert, at block 345 the processor 202 can then cause the audio stream to be played through the speakers on the XR system 110, or within the HMD 120, for example.

At decision block 340, if the critical alert is not an audio alert, then at decision block 350, the processor can determine whether the critical alert is a warning alert. A warning alert can be a spatial notification indicating when the HMD 120—and the user—are approaching a dangerous position (e.g., the warning zone 122, the warning zone 126) within the environment 100. The location monitor 222 can provide such indication to the processor 202 that can determine proximity to the table 124 or the couch 128, for example, based on the areas identified as the warning zone 122 and the warning zone 126. The warning zones 122, 126 can be user-defined.

If the critical alert is a warning alert, then the processor 202 can activate the external camera 224 on the device 200 (e.g., the HMD 120) to display the real world to the user so that the user can avoid furniture or other hazards associated with the warning zones 122, 126.

If at decision block 350, the processor determines that the critical alert does not require streaming video or audio from another component, at block 360 the processor 202 can display an indication on the display of the HMD 120, for example. In some embodiments, the indication can be symbols, text, images, or video indicating a critical event. Such video can be a video stream of, for example, the environment 100, (e.g., from the camera 224) or from the security camera 130n. As noted above, events defined as critical events or critical alerts can be user defined. Accordingly, any critical events not associated with security (block 335), audio (block 345), and video (block 355) can be indicated with text or other symbols within the HMD 120. For example, if the user defines the completion of a washing machine cycle as a critical event, then the processor 202 can display text indicating the completion of the washing machine cycle.

Those of skill will appreciate that the various illustrative logical blocks (e.g., the various servers described herein), and method/algorithm steps described in connection with the embodiments disclosed herein can often be implemented as electronic hardware, computer software, or combinations of both. To clearly illustrate this interchangeability of hardware and software, various illustrative components, blocks, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the disclosure. In addition, the grouping of functions within a block or step is for ease of description. Specific functions or steps can be moved from one module or block without departing from the disclosure.

The various illustrative blocks or steps described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

What is claimed is:

1. A method for operating a virtual reality (VR) system having a head mounted device (HMD) to provide alerts, the method comprising:
storing, in a memory, one or more sound patterns, each sound pattern of the one or more sound patterns being associated with one of a critical event and a non-critical event;
receiving, at a processor, a notification from a home device of one or more of home devices, the notification indicating a status change of the home device;
determining that the notification corresponds to a critical event based on the one or more sound patterns; and
providing a critical message via the HMD of the VR system indicating that the critical event has occurred.

2. The method of claim 1 further comprising:
receiving a spatial notification based on a georeferenced boundary in a vicinity of the HMD; and
providing the critical message based on the georeferenced boundary.

3. The method of claim 2 further comprising
determining the notification corresponds to a non-critical event based on the one or more sound patterns; and
providing a non-critical message to a mobile device having a paired connection to the VR system.

4. The method of claim 1, wherein the notification comprises one of an alert sound emitted by the home device and a verbal statement.

5. The method of claim 4, wherein the critical message comprises one of:
displaying a text message via the HMD;
providing live audio from an external source via the HMD; and
providing live video from an external camera via the HMD.

6. The method of claim 1 further comprising providing the critical message via a visual display or an audio system of the HMD.

7. The method of claim 1 further comprising receiving the notification via a microphone coupled to the HMD.

8. The method of claim 1 further comprising receiving the notification via a microphone on a mobile device having a paired connection to the VR system.

9. The method of claim 1 further comprising selectively pausing a VR stream in response to the critical alert.

10. A device for providing an alert by a virtual reality (VR) system having a head mounted device (HMD), the device comprising:
a memory configured to store one or more sound patterns, each sound pattern of the one or more sound patterns being associated with one of a critical event and a non-critical event; and
one or more processors configured to
receive a notification from a home device of one or more of home devices, the notification indicating a status change of the home device,
determining that the notification corresponds to a critical event based on the one or more sound patterns, and
providing a critical message via the HMD of the VR system indicating the critical event has occurred.

11. The device of claim 10 wherein the processor is further configured to:
receive a spatial notification based on a georeferenced boundary in a vicinity of the HMD; and
provide the critical message based on the georeferenced boundary.

12. The device of claim 11 wherein the processor is further configured to:
determine the notification corresponds to a non-critical event based on the one or more sound patterns; and
provide a non-critical message to a mobile device having a paired connection to the VR system.

13. The device of claim 10, wherein the notification comprises one of an alert sound emitted by the home device and a verbal statement.

14. The device of claim 13, wherein the critical message comprises one of:
displaying a text message via the HMD;
providing live audio from an external source via the HMD; and
providing live video from an external camera via the HMD, the external camera being coupled to the HMD.

15. The device of claim 10 wherein the processor is further configured to provide the critical message via a visual display or an audio system of the HMD.

16. The device of claim 10 wherein the processor is further configured to receive the notification via a microphone coupled to the HMD.

17. The device of claim 10 wherein the processor is further configured to receive the notification via a microphone on a mobile device having a paired connection to the VR system.

18. The device of claim 10 wherein the processor is further configured to selectively pause a VR stream in response to the critical alert.

19. A non-transitory computer readable medium comprising instructions for providing an alert in a virtual reality (VR) system having a head mounted device (HMD), the instructions, when executed by a processor, cause a computer to:
store, in a memory, one or more sound patterns, each sound pattern of the one or more sound patterns being associated with one of a critical event and a non-critical event;
receive, at a processor, a notification from a home device of one or more of home devices, the notification indicating a status change of the home device;
determine that the notification corresponds to a critical event based on the one or more sound patterns; and
provide a critical message via the HMD of the VR system indicating the critical event has occurred.

20. The non-transitory computer readable medium of claim 19 further comprising instructions to cause the processor to:
receive a spatial notification based on a georeferenced boundary in the vicinity of the HMD; and
provide the critical message based on the georeferenced boundary.

21. The non-transitory computer readable medium of claim 20 further comprising instructions to cause the processor to:
determine the notification corresponds to a non-critical event based on the one or more sound patterns; and
provide a non-critical message to a mobile device having a paired connection to the VR system.

22. The non-transitory computer readable medium of claim 19, wherein the notification comprises one of an alert sound emitted by the home device and a verbal statement.

23. The non-transitory computer readable medium of claim 22, wherein the critical message comprises one of:
displaying a text message via the HMD;
providing live audio from an external source via the HMD; and
providing live video from an external camera via the HMD.

24. The non-transitory computer readable medium of claim 19 further comprising instructions to cause the processor to provide the message via a visual display or an audio system of the HMD.

25. The non-transitory computer readable medium of claim 19 further comprising instructions to cause the processor to receive the notification via a microphone coupled to the HMD.

26. The non-transitory computer readable medium of claim 19 further comprising instructions to cause the processor to receive the notification via a microphone on a mobile device having a paired connection to the VR system.

27. The non-transitory computer readable medium of claim 19 further comprising instructions to cause the processor to selectively pause a VR stream in response to the critical alert.

28. A method for providing an alert by a virtual reality (VR) system having a head mounted device (HMD), the method comprising:
storing, in a memory,
a georeferenced boundary associated with a corresponding warning zone, and
one or more sound patterns, each sound pattern of the one or more sound patterns being associated with one of a critical event and a non-critical event;
detecting, at a processor, an alert;
if the alert comprises an audible notification from a home device of one or more of home devices,
determining that the notification corresponds to a critical event based on the one or more sound patterns, and
providing a critical message via the HMD of the VR system indicating the critical event has occurred; and
if the alert comprises an indication that the HMD is approaching the georeferenced boundary, providing a video feed of an external environment via the HMD.

29. The method of claim 28 wherein providing the critical message comprises one of:
displaying a text message via the HMD;
providing live audio from an external source via the HMD; and
providing live video from an external camera via the HMD.
